(19) United States
(12) Patent Application Publication
(10) Pub. No.: US 2010/0192193 A1
(43) Pub. Date: Jul. 29, 2010

(54) SECURITY RESTRICTION TECHNIQUES FOR BROWSER-BASED APPLICATIONS

(75) Inventors: Elisabeth Katarina Olson, Bellevue, WA (US); Shaofeng Zhu, Bellevue, WA (US); Joseph Maxwell Golden, Seattle, WA (US); Michael Ammerlaan, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/358,268

(22) Filed: Jan. 23, 2009

(51) Int. Cl. G06F 21/00

(52) U.S. Cl. 726/1

(57) ABSTRACT

Various technologies and techniques are disclosed for restricting security levels that can be used with browser-based applications. When a request is received from an external application to retrieve data for use in a client browser, an intersection is performed on a permission set of a user of the client browser and of the external application to determine a new permission set to use for retrieving the requested data. Techniques for restricting operations of an external application that is being run in a client browser are also described. A session token is returned to a client browser after validating access can be granted to the client browser. Validation is performed to confirm access can be granted to an external application. A request for data is received from the external application, with the request for data containing the session token. The requested data is retrieved and returned to the external application.

### BACKGROUND

In today's world of technology, a large number of applications run over the Internet in a web browser. In such environments, there is often an external component hosted by a third party that needs to be given access to the user's account on another system in order to provide its desired functionality. An example of such an external component can be a third party chart control that displays data from a content management application in interesting ways.

In order to allow external applications to provide rich functionality in such browser applications, it is sometimes necessary to allow these external applications to operate on behalf of users. However, it can often be difficult to determine what security permissions to let the application use. If the application itself has a permission level which is used to limit its actions, then the application is limited from doing anything above that permission level. But this doesn't limit a user's ability to elevate their permission level. For example, an application might have permission to write to a list, while a user might only have permission to read the list. In this situation, the user could use the application to write to the list, thus gaining a permission they are not supposed to have.

On the other hand, if the external application is limited by the permissions of the user who is using it, the application can elevate its permissions based upon the user interacting with it. This might occur, for example, when the external application has read-only permissions but is used by a user that has write permissions. In this latter scenario, the external application could use the user's permission to write data, possibly without the user even knowing about it. Thus, any time an external application is given authority to take an action based upon either the external application's security permission or the user's security permission level, there is an opportunity for an unauthorized elevation of permissions to occur.

### SUMMARY

Various technologies and techniques are disclosed for restricting security levels that can be used with browser-based applications. When a request is received from an external application to retrieve data to be used by the external application within a client browser, an intersection is performed on a permission set of a user of the client browser and of the external application to determine a new permission set to use for retrieving the data requested by the external application.

A method for restricting operations that can be performed by an external application that is being run in a client browser is described. A request is received from a client browser to login to an original application. A session token is returned to the client browser after validating that access to the original application can be granted to the client browser. While the client browser is still logged in to the original application, a request is received from an external application to login to the original application. Validation is performed to confirm that access to the original application can be granted to the external application. A request for data is received from the external application, with the request for data containing the session token that the external application obtained from the client browser.

While the client browser and external application are both still logged in to the original application, the data requested by the external application is retrieved. In one implementation, an intersection is performed on a permission set of a user of the client browser and of the external application to determine a new permission set to use for retrieving the data requested by the external application. The data is returned to the external application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system for restricting permission levels of external applications of one implementation.

FIG. 2 is a process flow diagram for one implementation illustrating the stages involved in restricting the permission level of an external application being accessed from a client browser.

FIG. 3 is a process flow diagram for one implementation illustrating the stages involved in performing an intersection on the permission set of the external application and on a user of the client browser to determine a new permission level to use.

FIG. 4 is a diagrammatic view of three exemplary permission intersections between a user's account permissions and an external application's permissions.

FIG. 5 is a diagrammatic view of a computer system of one implementation.

### DETAILED DESCRIPTION

The technologies and techniques herein may be described in the general context as an application that restricts the permission level that external applications can use when running in a client browser, but the technologies and techniques also serve other purposes in addition to these. In one implementation, one or more of the techniques described herein can be implemented as features within any other type of program or service that allows external applications to access data on behalf of a user.

In one implementation, a user account for an original application is assigned to an external application (or to the server hosting the external application, etc.) The term “original application” as used herein is meant to include any type of application that has functionality that needs to be accessed by an external application for use in a client browser. The term “external application” as used herein is meant to include an application that resides on a separate process boundary or server from the original application, such as on a third party server. The term “client browser” as used herein is meant to include a web browser that resides on a device being operated by a user.

The user account for the original application that is assigned to the external application is marked with a special indicator so that the external application will only be granted permissions to the original application if the user is also separately logged in to the original application. When the user logs in to the original application, a session token is returned back to the client browser. The term “session token” as used herein is meant to include an identifier assigned to the user's current session in the client browser. That session token is provided to the external application by the client browser. That way, when the external application makes requests for data from the original application, the original application will know what user session the application is associated with.

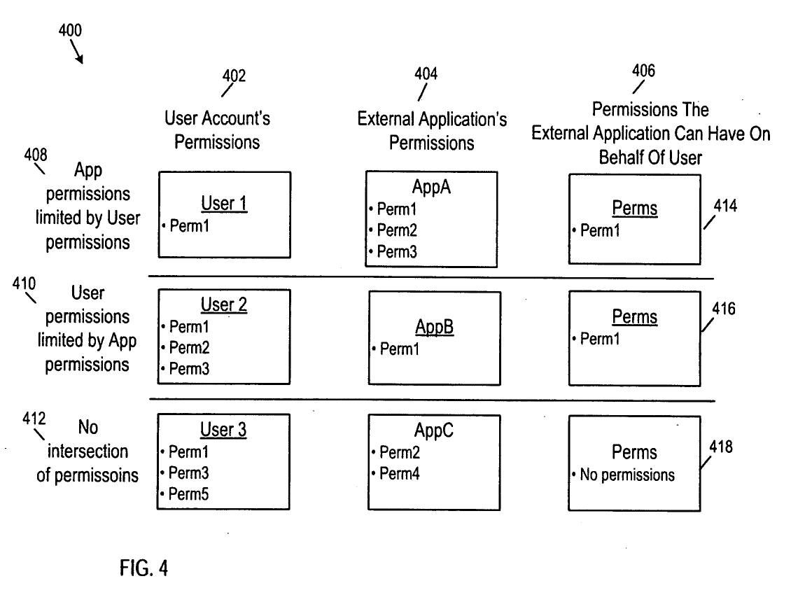

In one implementation, the system also performs an intersection of permissions between the user's permission level and the external application's permission level to determine a new permission set to use for any operations requested by the external application. The term “performing an intersection” or “performs an intersection” as used herein is meant to include the process of doing an AND operation on the permissions between the two accounts to determine a new permission set. In an “AND” operation, only permissions that are contained in each set of permissions will be included in the new permission set. The term “new permission set” as used herein is meant to include the list of zero or more permissions that result after performing an intersection. Several examples of performing an intersection are shown in FIG. 4.

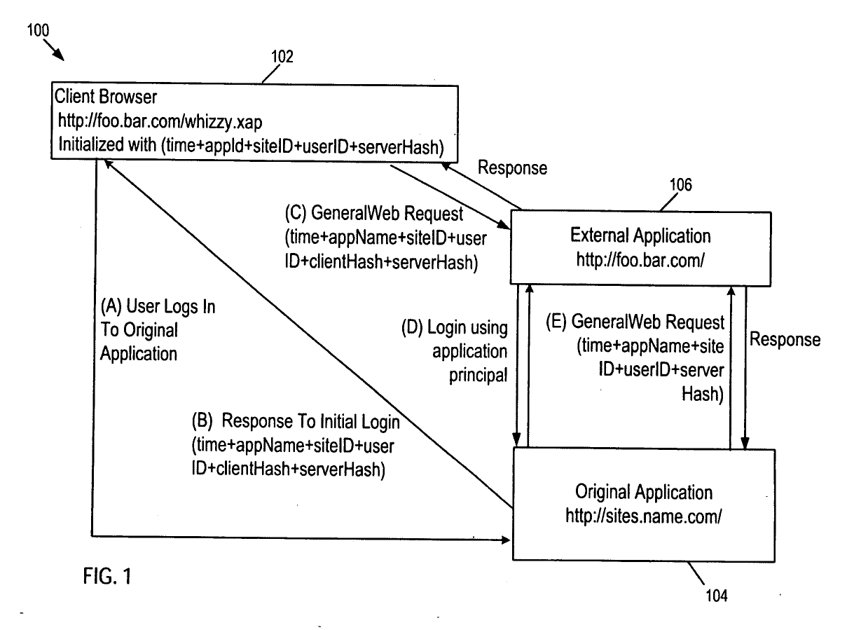

FIG. 1 is a diagrammatic view of one implementation of a system 100 for restricting permission levels of external applications. System 100 includes a client browser 102, original application 104, and an external application 106. Original application 104 can be an application such as a content management application or any type of application that has data that is being requested by client browser 102 and/or the client component of external application 106 that is running within client browser 102. External application 106 can be any type of application that resides on a separate application domain or server from original application 104. For example, external application 106 can be a component that is being displayed in client browser 102 that needs access to data contained in original application 104 in order to perform its intended functionality. One non-limiting example of an external application 106 can include a chart component that gets displayed in client browser 102 with data from original application 104 organized in a particular type of chart. External application 106 can be of virtually any type of component that is used within client browser 102, but that needs access to data from original application 104 in order to perform at least part of its desired function.

In one implementation, a user account for the original application 104 is assigned to the external application 106. As a few non-limiting examples, a separate user account for the external application can be assigned to each server that runs the external application, just one for the external application overall, or the user account could be shared by all applications that the server running the external application hosts. Numerous other configurations of assigning one or more user accounts for use by the external application 106 could also be used.

The user account for the original application 104 that is assigned to the external application 106 is marked with a special indicator so that the external application 106 will only be granted permissions to the original application 104 if the user is also separately logged in to the original application. When the user logs in to the original application 104 from client browser 102, a session token is returned back to the client browser. The session token can be in one of a variety of formats, and can include identifiers such as a time identifier, an application identifier, and/or a user identifier. Any data that uniquely identifier this particular session by the user could be included within the session token.

That session token is then provided to the external application by the client browser. When the client browser 102 makes the request to external application 106 to perform some functionality that requires data from original application 104, client browser 102 provides the session token to external application 106. That way, when the external application 106 makes requests for data from the original application 104, the original application 104 will know what user session the external application 106 is associated with and will only allow the requested operation to be performed if both the user and the external application are logged in and are using the same session token.

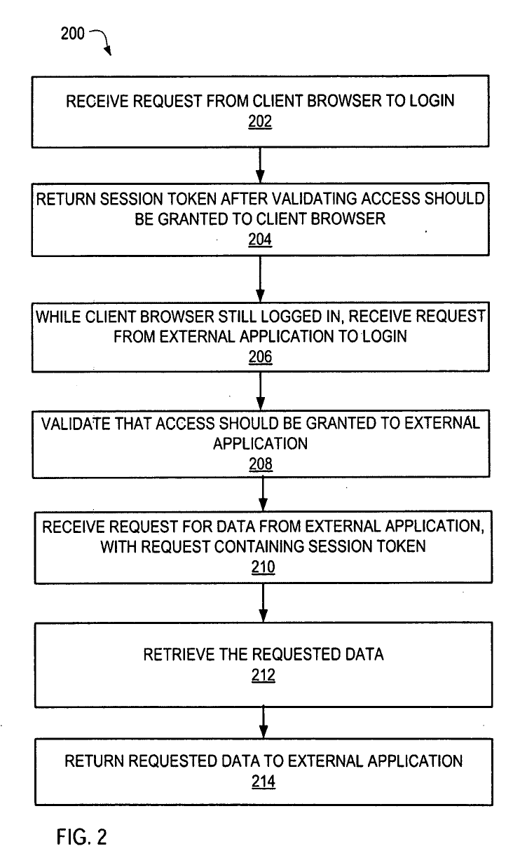

In one implementation, before any operation can be performed by the external application 106 against the original application 104, the original application 104 performs an intersection of permissions between the user's permission level from the client browser 102 and the external application's permission level 106 to determine a new permission set to use for any operations requested by the external application, such as those that retrieve data. These concepts will now be described in further detail in FIGS. 2-4.

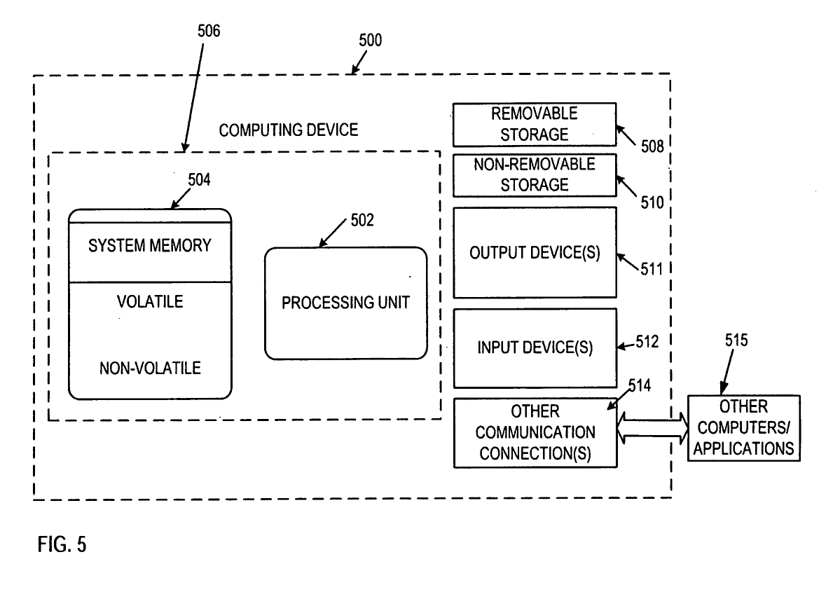

Turning now to FIGS. 2-4, the stages for implementing one or more implementations of system 100 are described in further detail. In some implementations, the processes of FIG. 2-4 are at least partially implemented in the operating logic of computing device 500 (of FIG. 5).

FIG. 2 is a process flow diagram 200 that illustrates one implementation of the stages involved in restricting the permission level of an external application being accessed from a client browser. A request is received from a client browser to login to an original application (stage 202). As noted earlier, a non-limiting example of the original application can include a content management or other application that is being accessed by the user from client browser. The original application then verifies that valid user credentials are specified. A session token is returned to the client browser after validating that access to the original application can be granted to the client browser (stage 204). In one implementation, a session token is only returned to the client browser when there is an external application running in the client browser that will need access to the original application. The session token is provided by the client browser to the external application so the external application can later retrieve the data it needs from the original application.

While the client browser is still logged in to the original application, a request is also received from an external application to login to the original application (stage 206). The external application can be one of a variety of application types, but in general is a component or application that is providing some functionality to the client browser that needs to retrieve at least some of its information from the original application. The original application validates that access to the original application can be granted to the external application (stage 208), such as by confirming that a valid set of user credentials were supplied by the external application. As noted earlier, the original application can look at a special indicator that is associated with the account of the external application to see that the external application can only be allowed to access functionality of the original application if the user is separately logged in to the original application.

At some point in time after logging in, the external application then sends a request to the original application for the data that it needs to use in the client browser. That request includes the session token that was given to the external application by the client browser. The request for data is received by the original application from the external application (stage 210). The data requested by the external application is retrieved (stage 212). The original application will verify that the session token matches with the token previously supplied to the client browser before retrieving the requested data.

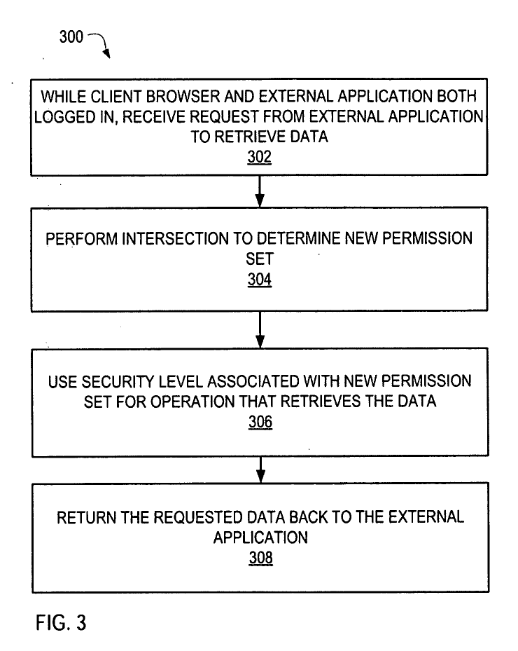

In another implementation, the original application will perform an intersection on the permissions of the user and the external application to generate a new permission set, and will then use the new permission set to determine what security level to use for the data retrieval operation. This process is described in more detail in FIG. 3. If the validation of the session token is successful, then the data is returned to the external application (stage 214). The external application can then further manipulate the data and then display or otherwise use the data in the client browser.

FIG. 3 is a process flow diagram 300 that illustrates one implementation of the stages involved in performing an intersection on the permission set of the external application and on a user of the client browser to determine a new permission level to use. While the client browser and the external application are both logged in, a request is received from the external application to retrieve data (stage 302). An intersection is performed between the user's permission set associated with the client browser and the external application's permission set to determine the new permission set (stage 304). Some additional examples of how intersections work are shown in FIG. 4 to illustrate the concept more clearly.

The security level associated with the new permission set is then used for the operation that retrieves the data (stage 306). This new permission set that results from the intersection will prevent an elevation of privilege by the user and the external application. In other words, neither the user nor the external application will be able to perform any operation that they are not entitled to perform. The requested data is then returned back to the external application (stage 308). As noted earlier, the external application can then further manipulate the data and display or use it in some fashion with the client browser.

Turning now to FIG. 4, a diagrammatic view of three exemplary permission intersections 400 between a user's account permissions and an external application's permissions are illustrated. There example scenarios illustrate how an intersection of the user's permissions 402 with the external application's permissions 404 can result in the new permission set 406 that is then allowed to be used by the external application when accessing the original application. In the first example 408, the user has fewer permissions than the external application, so the resulting permission set 414 will limit the external application's permissions. In the second example 410, the user has more permissions than the external application, so the resulting permission set 416 will limit the user's permissions for what can be performed by the external application. In the third example 412, there is no intersection of permissions, so the resulting permission set 418 is actually empty. In other words, the external application will not have authority to perform any operations against the original application.

As shown in FIG. 5, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
when receiving a request from an external application to retrieve data to be used by the external application within a client browser, performing an intersection on a permission set of a user of the client browser and of the external application to determine a new permission set to use for retrieving the data requested by the external application.

2. The computer-readable medium of claim 1, further having computer-executable instructions for causing a computer to perform steps comprising:
using a security level associated with the new permission set for an operation that retrieves the data; and
returning the data to the external application.

3. The computer-readable medium of claim 1, wherein the new permission set prevents an elevation of privilege by the user and the external application.

4. The computer-readable medium of claim 1, wherein the external application is provided by a third party.

5. The computer-readable medium of claim 1, wherein the external application is hosted on a separate application domain.

6. The computer-readable medium of claim 1, wherein the request from the external application includes a session token that was originally provided to the client browser.

7. The computer-readable medium of claim 1, further having computer-executable instructions for causing a computer to perform steps comprising:
prior to performing the intersection, ensuring that the user of the client browser is logged in and that the external application is logged in.

8. The computer-readable medium of claim 1, wherein the external application is a component that gets rendered in the client browser.

9. A method for restricting operations that can be performed by an external application that is being run in a client browser comprising the steps of:
receiving a request from a client browser to login to an original application;
returning a session token to the client browser after validating that access to the original application can be granted to the client browser;
while the client browser is still logged in to the original application, receiving a request from an external application to login to the original application;
validating that access to the original application can be granted to the external application;
receiving a request for data from the external application, with the request for data containing the session token that the external application obtained from the client browser;
retrieving the data requested by the external application; and
returning the data to the external application.

10. The method of claim 9, further comprising the steps of:
prior to retrieving the data, performing an intersection on a permission set of a user of the client browser and of the external application to determine a new permission set, and using the new permission set when retrieving the data.

11. The method of claim 10, wherein the new permission set prevents an elevation of privilege by the user and the external application.

12. The method of claim 9, wherein at least some of the data being returned to the external application is data to be displayed in the client browser.

13. The method of claim 9, wherein the external application is provided by a third party.

14. The method of claim 9, wherein the external application is hosted on a separate application domain from the original application.

15. The method of claim 9, wherein the external application is a component that gets rendered in the client browser.

16. The method of claim 9, wherein the session token is provided to the external application by the client browser when the client browser requests that the external application render data that is contained in the original application.

17. The method of claim 9, wherein the session token includes a time identifier, application identifier, and user identifier.

18. A method for restricting operations that can be performed by an external application that is being run in a client browser comprising the steps of:
receiving a request from a client browser to login to an original application;
returning a session token to the client browser after validating that access to the original application can be granted to the client browser;
while the client browser is still logged in to the original application, receiving a request from an external application to login to the original application;
validating that access to the original application can be granted to the external application;
receiving a request for data from the external application, with the request for data containing the session token that the external application obtained from the client browser;
while the client browser and external application are both still logged in to the original application, performing an intersection on a permission set of a user of the client browser and of the external application to determine a new permission set;
using a security level associated with the new permission set for an operation that retrieves the data; and
returning the data to the external application.

19. The method of claim 18, wherein the external application is a component that gets rendered in the client browser.

20. The method of claim 18, wherein the session token includes a time identifier, application identifier, and user identifier.
